(19) United States
(12) Patent Application Publication
(10) Pub. No.: US 2008/0099470 A1
(43) Pub. Date: May 1, 2008

(54) Method of Fixing a Needle Cannula In a Radiation Transmissive Body

(75) Inventors: Martin Von Bülow, Helsing&oslash;r (DK); Per Wragard Pedersen, Hjorring (DK); Henning Jakobsen, Randers (DK)

Correspondence Address: NOVO NORDISK, INC.;PATENT DEPARTMENT, 100 COLLEGE ROAD WEST, PRINCETON, NJ, 08540, US

(73) Assignee: Novo Nordisk A/S, Bagsv&aelig;rd (DK)

(21) Appl. No.: 11/663,869

(22) PCT Filed: Sep. 22, 2005
(86) PCT No.: PCT/EP05/10247

§ 371 Date: Oct. 5, 2007

(30) Foreign Application Priority Data
Sep. 27, 2004 (EP) 04077655.1

(51) Int. Cl. H05B 6/64

(52) U.S. Cl. 219/678

(57) ABSTRACT

A metallic needle cannula is fixed inside a body by laser welding, whereby adhesives are not required. Metallic materials have large absorptions of all electromagnetic radiation, whereby a wider range of possible materials and wavelength is provided for the body and the radiation.

The present invention relates to the providing of a body having therein a needle cannula. This body may be provided for fixing the needle cannula to a container having therein a drug to be injected into a person or animal.

A problem encountered when providing an assembly of this type is the fixing of the needle cannula in the body in a quick and safe manner. Normally, this is achieved using an adhesive or glue. However, due to the environmental problems caused by these agents, alternative methods have been sought for.

In the prior art, welding, also in relation to medical products, have been described, a.o. in: U.S. Pat. No. 5,485,614, 2003/201059, U.S. Pat. No. 4,409,046, 2004/0118902, U.S. Pat. No. 6,428,503, EP-A-1234595 and 0885622 as well as in RU 2102086.

The present invention relates to a method of fixing a metallic syringe or needle in a radiation transmissive body, the method comprising:
providing the transmissive body with an opening or channel,
positioning a part of the needle cannula in the opening or channel,
providing radiation of a wavelength, to which the body is transmissive, into the body and on to the part of the needle cannula so as to heat the needle cannula and thereby melt material of the body adjacent to the part of the needle cannula,
cool the melted material in order to fix the needle cannula in the body.

Thus, due to the fact that the needle cannula is fixed by simply melting the material of the body, no adhesive or glue is required. Thus, only the materials of the needle cannula and the body need fulfil the requirements relating to injection devices. These types of materials are well known and well documented.

Preferably, the step of providing the radiation comprises providing radiation having a wavelength of 0.5 μm to 5 μm. Wavelengths normally used will relate to standard laser sources, such as laser diodes or high power gas lasers and such wavelengths may be 1064, 940, and 808 nm.

In the present context, the body is transmissive for the radiation when it does not absorb too much of the radiation. Otherwise, the needle cannula may be insufficiently heated to make the welding occur. A too high absorption in the body may also bring about deformation/melting/colouring of the body, which may be undesired. Thus, preferably, the transmission coefficient, or the absorption coefficient of the material of the body is selected so that at least 80%, such as at least 85%, preferably at least 90% of the incident radiation reaches the cannula.

It is noted that unlike the known types of laser welding, where a plastic or polymeric material is to be heated by the radiation, a metallic material is heated in accordance with the invention. Thus, as all metals have a very high absorption of all electromagnetic radiation, the only requirement, in respect of the fixing of the needle cannula, of the material of the body is a sufficient transmission of the radiation wavelength and the meltability at the temperature reached by the needle cannula.

An alternative is one wherein the step of providing the body comprises a body having a predetermined material in the opening or channel, wherein the step of providing the radiation comprises the needle cannula heating the predetermined material, and wherein the cooling step comprises cooling the melted predetermined material so as to fix the needle cannula to the remainder of the body. Consequently, the thermo plastic properties desired may be provided by the predetermined material and are not required by the bulk of the material of the body.

This predetermined material may be any other material than that of which the body is made. Also, this material may, in fact, have a non-zero absorbance of the radiation so that the radiation will heat and melt this material, whereby the molten material may solidify and seal the cannula to the remainder of the body. In this situation, it may be desired that this predetermined material may have a thickness, in the direction of the laser radiation, so low that the material is melted all along this direction. Thus, this material may be that which actually provides the heating required to fix the cannula within the body.

In one embodiment, the step of providing the transmissive body comprises providing the transmissive body and subsequently providing the opening or channel therein.

In order to ensure a sufficient fixing and/or sealing between the needle cannula and the body, it may be preferred that the part of the needle cannula has a cylindrical outer surface having a predetermined outer diameter, and wherein the step of providing the opening/channel in the body comprises providing a cylindrical opening/channel having an internal diameter equal to or slightly larger than the outer diameter of the needle cannula. In this manner, an abutment or biasing may be provided between the needle and the body prior to providing the radiation. Alternatively, a controlled space is present between the body and needle—a space that is closed by the melted material of the body in order to provide a suitable seal between the body and the needle.

Depending on the metal/alloy used, the metallic needle cannula will have a sufficient thermal conductivity for it to be heatable at one position and then transport heat to other parts thereof and melt adjacent parts of the body. Thus, it is not required to provide radiation to all parts of the needle cannula which are to be fixed to the body.

Nevertheless, it is preferred that the step of providing the radiation comprises rotating the body and needle cannula in relation to a direction of the radiation. Preferably this rotation is around an axis of the needle cannula. In this manner, it is ensured that a sufficient melting and a complete sealing of the needle cannula inside the body is obtained.

Radiation may be provided at both ends of the channel/opening in order to prevent space or room for impurities or drug to settle in.

Preferably, the needle cannula is a steel needle.

Another aspect of the invention relates to a needle assembly prepared using the above method.

In the following, a preferred embodiment of the invention will be described with reference to the drawing, wherein:

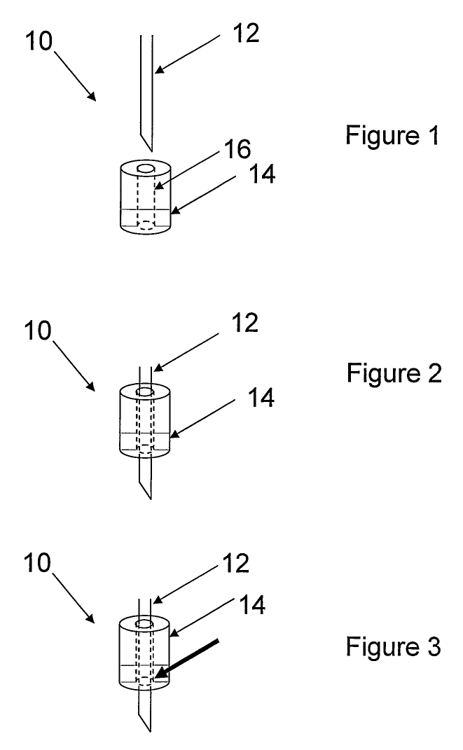

FIG. 1 illustrates the needle cannula prior to assembly,

FIG. 2 illustrates the needle cannula during assembly, and

FIG. 3 illustrates the laser welding of the assembly.

FIG. 1 illustrates the two parts, the needle cannula 12 and the body 14 into which the needle is to be welded. The body 14 either has or is provided with an opening 16 or, as in the present situation, a channel or hole, which is large enough to accommodate the outer diameter of the needle cannula 12 but which still has an inner diameter so small that the needle 12 when heated will melt material of the body 14 and that this melted material will make contact to and provide a seal to the needle 12 when cooled.

The body 14 may be used for fixing the needle 12 in relation to a container with a drug to be dispensed, such as a pen for injecting insulin into a patient. Thus, the body 14 may have a thread or the like (not illustrated) for fixing the body 14 and needle 12 in relation to the container or the like.

In FIG. 2, the needle 12 has been introduced into the channel 16, and in FIG. 3, laser radiation (fat arrow) is provided through the material of the body 14 and to the needle 12 in order for the needle 12 to be heated thereby.

The weld is preferably positioned at the ends of the channel 16 in order to have the melted, cooled material of the body 14 seal any inner cavity between the needle 12 and body 14 which might otherwise house impurities.

Excessive absorption of the laser radiation in the material of the body 14 will bring about melting of the body 14 at other positions than those adjacent to the needle 12, which is not normally desired. Consequently, the wavelength of the radiation and the material of the body 14 are preferably chosen so that this does not occur.

If the material of the desired body 14 is not a thermo plastic material, a thermo plastic material may be provided inside the channel 16 so as to be melted by the laser radiation (fat arrow) or the heated needle 14 and thereby weld the needle 12 to the body 14 via the melted material.

In order to ensure a suitable weld of the needle 12 in the body 14, the needle 12 and body 14 may be rotated in relation to the laser so that the needle 12 is evenly heated, around its circumference, by the laser radiation, whereby the material of the body 14 is evenly melted and an even weld is obtained. In this situation, the actual cannula may be used for rotating the assembly during welding.

1. A method of fixing a metallic needle cannula in a radiation transmissive body, the method comprising:
providing the transmissive body with an opening or channel,
positioning a part of the needle cannula in the in the opening or channel,
providing radiation of a wavelength, to which the body is transmissive, into the body and on to the part of the needle cannula so as to heat the needle cannula and thereby melt material of the body adjacent to the part of the needle cannula,
cool the melted material in order to fix the needle cannula in the body.

2. A method according to claim 1, wherein the step of providing the radiation comprises providing radiation having a wavelength of 0.5 μm to 5 μm.

3. A method according to claim 1, wherein the step of providing the body comprises a body having a predetermined material in the opening or channel, wherein the step of providing the radiation comprises the needle cannula heating the predetermined material, and wherein the cooling step comprises cooling the melted predetermined material so as to fix the needle cannula to the remainder of the body.

4. A method according to any of claim 1, wherein the step of providing the transmissive body comprises firstly providing the transmissive body and subsequently providing the opening or channel therein.

5. A method according to claim 4, wherein the part of the needle cannula has a cylindrical outer surface having a predetermined outer diameter, and wherein the step of providing the opening/channel in the body comprises providing a cylindrical opening/channel having an internal diameter equal to or slightly larger than the outer diameter of the needle cannula.

6. A method according to claim 1, wherein the step of providing the radiation comprises rotating the body and needle cannula in relation to a direction of the radiation.

7. A method according to claim 1, wherein the cannula is a steel cannula.

8. A needle assembly comprising a needle cannula fixed inside a body, the assembly having been prepared by the method according to claim 1.
